(19) United States
(12) Patent Application Publication
(10) Pub. No.: US 2007/0276666 A1
(43) Pub. Date: Nov. 29, 2007

(54) Method and Device for Selecting Acoustic Units and a Voice Synthesis Method and Device

(75) Inventors: Olivier Rosec, Lannion (FR); Soufiane Rouibia, Nantes (FR); Thierry Moudenc, Perros-Guirec (FR)

Correspondence Address: YOUNG & THOMPSON, 745 SOUTH 23RD STREET, 2ND FLOOR, ARLINGTON, VA, 22202, US

(73) Assignee: FRANCE TELECOM, Paris (FR)

(21) Appl. No.: 11/662,652

(22) PCT Filed: Aug. 30, 2005
(86) PCT No.: PCT/FR05/02166

§ 371 Date: Mar. 13, 2007

(30) Foreign Application Priority Data
Sep. 16, 2004 (FR) 0409822

(51) Int. Cl. G10L 13/00

(52) U.S. Cl. 704/260; 704/E13.001

(57) ABSTRACT

A method for selecting acoustic units each of which contains a natural speech signal and symbolic parameters involves a stage (4) for determining at least one target symbolic unit sequence; a stage (5) for determining a contextual acoustic model sequence corresponding to the target sequence; a stage (6) for determining an acoustic template on the basis of the contextual acoustic model sequence and a stage (7) for selecting the acoustic unit sequence according to the acoustic template applied to the target symbolic unit sequence. The invention is used for voice synthesis.

This invention relates to a process for the selection of acoustic units corresponding to the acoustic production of symbolic units. These acoustic units contain natural speech signals and each comprise a plurality of symbolic parameters representing acoustic characteristics.

Such selection processes are used, for example, in the context of speech synthesis.

In general a spoken language can be broken down into a finite basis of symbolic units of a phonological nature, such as phonemes or other units, as a result of which any text statement can be vocalised.

Each symbolic unit may be associated with a subset of natural speech segments, or acoustic units, such as phones, diaphones or other units, representing variations in the pronunciation of the symbolic unit.

In fact, for a single symbolic unit, a so-called corpus approach can be used to define a corpus of acoustic units of variable size and parameters recorded in different linguistic contexts and with different prosodic variants.

There then arises the problem of selecting these units in relation to the application context to minimise discontinuities during concatenation and reduce resort to prosodic modification algorithms.

In order to permit the automatic processing of these acoustic units each one comprises a plurality of symbolic parameters representing acoustic characteristics through which they can be represented in mathematical form.

There are processes for selecting acoustic units, in particular in the context of voice synthesis processes, which use a finite number of contextual acoustic models to model a target sequence of symbolic units and carry out selection.

One example of such a synthesis process is described in particular in the documents entitled “The IBM Trainable Speech Synthesis System” published by Donovan R. E. and Eide E. M., Proc. ICSLP, Sydney, 1998, or “Automatically Clustering Similar Units for Unit Selection in Speech Synthesis” published by Black A. W. and Taylor P., Proc. Eurospeech, pp. 601-604, 1997.

This type of process generally requires a prior stage of learning or determination of contextual acoustic models comprising the determination of probabilistic models, for example, of the type known as hidden Markov models, or HMM, and then classifying these on the basis of their symbolic parameters which may take their phonetic context into account. Thus contextual acoustic models are determined in the form of mathematical laws.

Classification is used to preselect acoustic units on the basis of their symbolic parameters.

Final selection generally involves cost functions based on a cost allocated to each concatenation of two acoustic units and a cost allocated to the use of each unit.

However, determination and ranking of these costs is carried out in an approximate manner and requires the intervention of a human expert.

As a consequence the selection made is not optimal and there is little control over the quality of the synthesised signal, making it impossible to evaluate its quality from the outset.

The object of this invention is to overcome this problem by providing a powerful process for the selection of acoustic units using a finite set of contextual acoustic models.

In this respect this invention relates to a process for selecting acoustic units corresponding to acoustic productions of symbolic units of a phonological nature, the said acoustic units each comprising a natural speech signal and symbolic parameters representing their acoustic characteristics, the said process comprising:
a stage of determining at least one target sequence of symbolic units, and
a stage of determining a sequence of contextual acoustic models corresponding to the said target sequence, characterised in that it further comprises:
a stage of determining an acoustic template from the said sequence of contextual acoustic models, and
a stage of selecting a sequence of acoustic units on the basis of the said acoustic template applied to the said target sequence of symbolic units.

Through the use of an acoustic template the process according to the invention makes it possible to take into account spectral, energy and duration information at the time of selection, thus permitting reliable selection of good quality.

According to other features of the invention:
the process includes a prior stage of determining contextual acoustic models based on a given set of acoustic units,
the said stage of determining contextual acoustic models comprises:
   a substage of determining a probabilistic model for each acoustic unit originating from a finite stock of models each comprising an observable random process corresponding to the acoustic production of symbolic units and a non-observable random process having known probabilistic properties known as “Markov properties”,
   a substage of classifying the said probabilistic models on the basis of their symbolic parameters,

the observable and non-observable random processes of the models for each class forming the said contextual acoustic models,
the said stage of determining the contextual acoustic models further comprises a substage of determining probabilistic models appropriate to the phonetic context whose parameters are used in the course of the said classification substage,
the said classification substage comprises classification through decision trees, the parameters of the said probabilistic models being modified by the course of the said decision trees to form the said contextual acoustic models,
the said stage of determining at least one target sequence of symbolic units comprises:
   a substage of acquiring a symbolic representation of a text, and
   a substage of determining at least one sequence of symbolic units from the said symbolic representation,
the said stage of determining a sequence of contextual acoustic models comprises:
   a substage of modelling the said target sequence by breaking it down on the basis of probabilistic models in order to deliver a sequence of probabilistic models corresponding to the said target sequence, and
   a substage of forming contextual acoustic models by modifying the parameter of the said probabilistic models to form the said sequence of contextual acoustic models,
the said stage of determining an acoustic template comprises:
   a substage of determining the time duration of each contextual acoustic model,
   a substage of determining a temporal sequence of models, and
   a substage of determining a sequence of corresponding acoustic frames forming the said acoustic template,
the said substage of determining the time duration of each contextual acoustic model comprises predicting its length,
the said stage of selecting a sequence of acoustic units comprises:
   a substage of determining a reference sequence of symbolic units from the said target sequence, each symbolic unit in the reference sequence being associated with a set of acoustic units, and
   a substage of alignment between the acoustic units associated with the said reference sequence and the said acoustic template,
the said selection stage further comprises a substage of segmentation of the said acoustic template on the basis of the said reference sequence,
the said segmentation substage comprises breaking down the said acoustic template on the basis of time units,
as the said template is segmented, each segment corresponds to a symbolic unit of the reference sequence and the said alignment substage comprises alignment of each segment of the template with each of the acoustic units associated with the corresponding symbolic unit taken from the reference sequence,
the said alignment substage comprises determining optimum alignment as determined by a so-called “DTW” algorithm.
the said selection stage further comprises a preselection substage through which possible acoustic sequences may be determined for each symbolic unit in the reference sequence, the said alignment substage comprising a substage of final selection from these possible units,
the said contextual acoustic models are probabilistic models with observable processes having continuous values and non-observable processes having discrete values forming the states in this process, and
the said contextual acoustic models are probabilistic models with non-observable processes having continuous values.

The invention also relates to a process for synthesising the speech signal, characterised in that it comprises a selection process as described previously, the said target sequence corresponding to a text which has to be synthesised and the process further comprising a stage of synthesising a vocal sequence from the said sequence of selected acoustic units.

According to other features the said synthesis stage comprises:
a substage of recovering a natural speech signal for each selected acoustic unit,
a substage of smoothing of the speech signals, and
a substage of concatenating different natural speech signals.

In correlation with this the invention also relates to a device for selecting acoustic units corresponding to acoustic productions of symbolic units of a phonological nature, this device comprising means designed to carry out a selection process as defined above, as well as a device for synthesising a speech signal, which is noteworthy in that it includes means designed to carry out such a selection process.

This invention also relates to a computer program on a data carrier, this program comprising instructions designed to carry out a process for selecting acoustic units according to the invention when the program is loaded and run in a data processing system.

The advantages of these devices and the computer program are the same as mentioned above in connection with the process of selecting acoustic units according to the invention.

The invention will be better understood from a reading of the following description provided purely by way of example with reference to the appended drawings, in which:

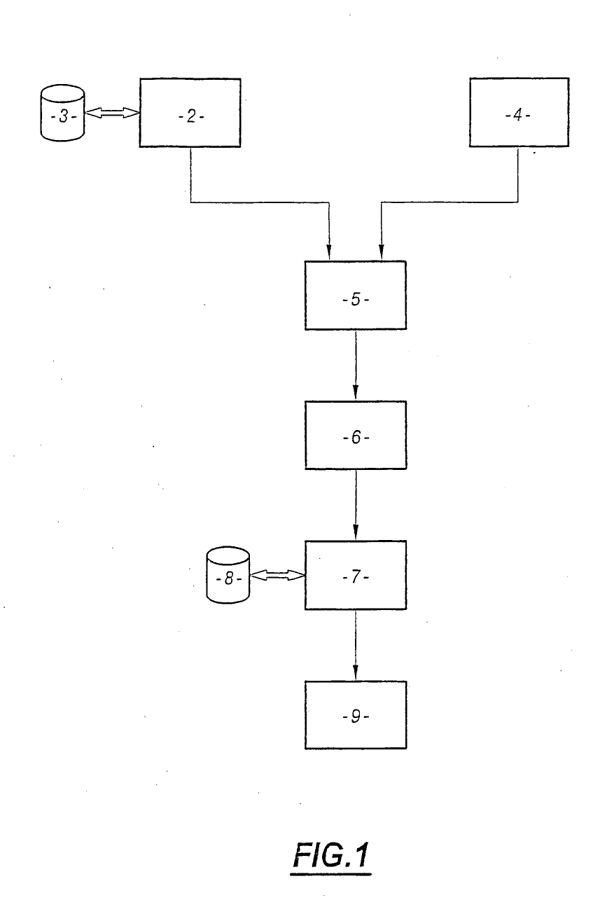

FIG. 1 shows a general flowchart for a process of voice synthesis using a selection process according to the invention,

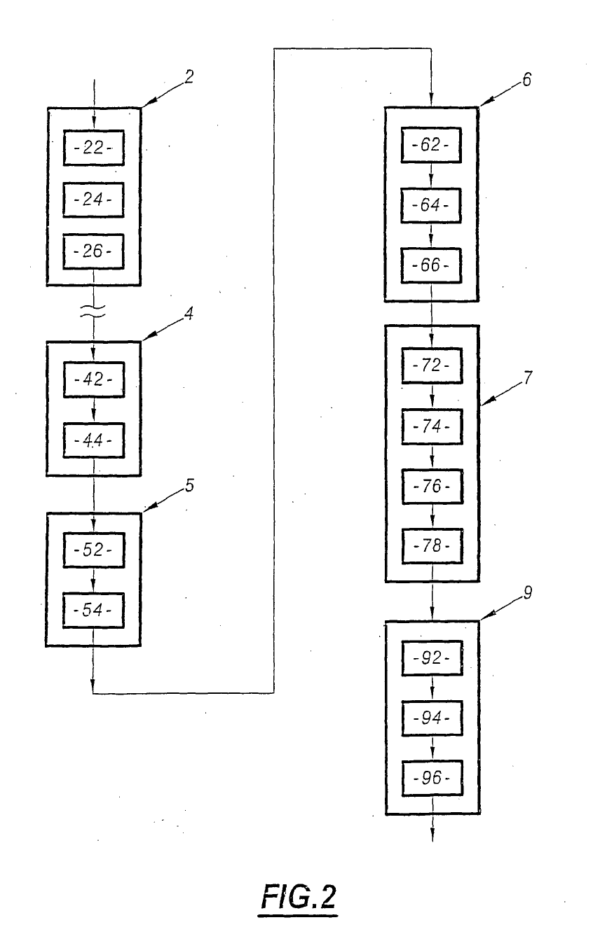

FIG. 2 shows a detailed flowchart of the process in FIG. 1, and

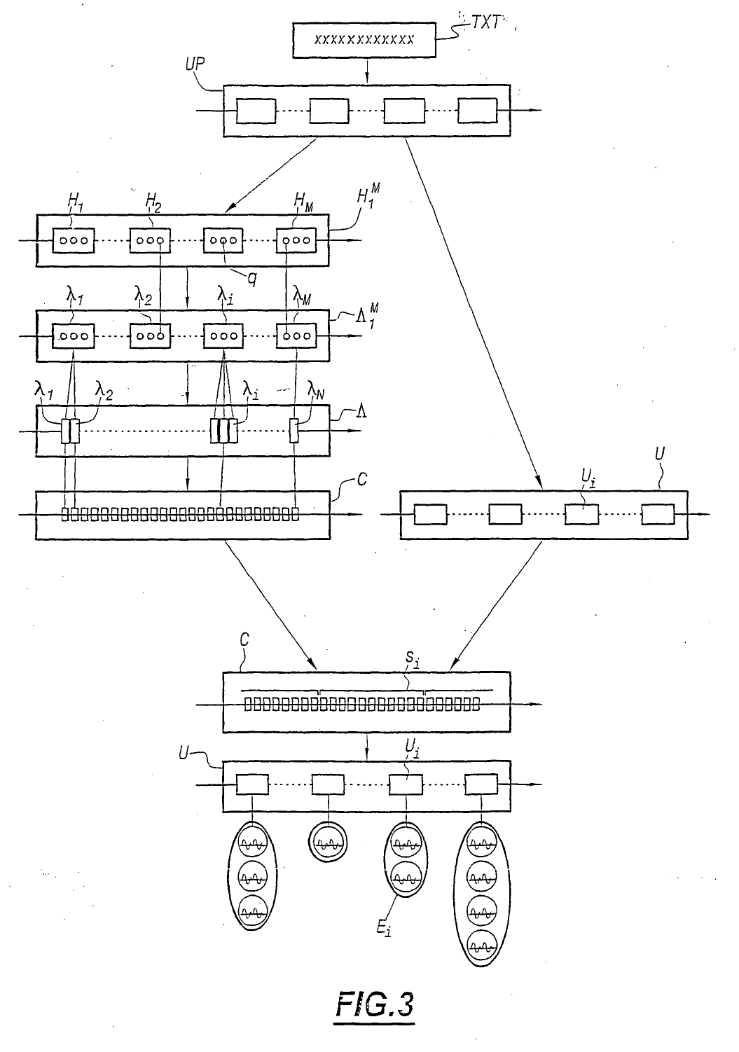

FIG. 3 shows details of the specific signals in the course of the process described with reference to FIG. 2.

FIG. 1 shows a general flowchart of the process according to the invention used in the context of a voice synthesis process.

According to a preferred embodiment, the stages in the process of selecting acoustic units according to the invention are determined by the instructions of a computer program used for example in a voice synthesis device.

The process according to the invention is then carried out when the aforesaid program is loaded into the data carrier incorporated in the device in question, the operation of which is then controlled by running the program.

By “computer program” is here meant one or more computer programs forming a set (software) whose purpose is to implement the invention when it is run by an appropriate data processing system.

As a consequence the invention also relates to such a computer program, in particular in the form of software stored on a data carrier. Such a data carrier may comprise any unit or device which is capable of storing a program according to the invention.

For example, the medium in question may comprise a physical storage medium such as a ROM, for example a CD ROM or a microelectronic circuit ROM, or magnetic recording means, for example a hard disk. As a variant, the data carrier may be an integrated circuit in which the program is incorporated, the circuit being designed to run or be used in running the process in question.

In addition to this the data carrier may also be a transmissible non-physical medium such as an electrical or optical signal which may be conveyed by an electrical or optical cable, by radio or by other means. A program according to the invention may in particular be remotely loaded onto a network of the Internet type.

From a design point of view, a computer program according to the invention may use any programming language and be in the form of source code, target code or an intermediate code between a source code and target code (e.g. a partly compiled form), or any other form which is desirable for implementing a process according to the invention.

Returning to FIG. 1, the selection process according to the invention comprises first of all a prior stage 2 of determining contextual acoustic models taken from a given set of acoustic units present in a database 3.

This determination stage 2 is also called learning and is used to define mathematical laws representing the acoustic units which each contain a natural speech signal and symbolic parameters representing their acoustic characteristics.

Following stage 2 of determining contextual acoustic models, the process comprises a stage 4 of determining at least one target sequence of symbolic units of a phonological nature. In the embodiment described this target sequence is unique and corresponds to a text which has to be synthesised.

The process then comprises a stage 5 of determining a sequence of contextual acoustic models such as those originating from prior stage 2 and corresponding to the target sequence.

The process further comprises a stage 6 of determining an acoustic template from the said sequence of contextual acoustic models. This template corresponds to the most likely spectral and energy parameters given the sequence of contextual acoustic models determined previously.

Stage 6 of determining an acoustic template is followed by a stage 7 of selecting acoustic units on the basis of this acoustic template applied to the target sequence of symbolic units.

The selected acoustic units originate from a given set of acoustic units for voice synthesis comprising a database 8 which is the same as or different from database 3.

Finally the process comprises a stage 9 of synthesising a voice signal from the selected acoustic units and database 8 in such a way as to reconstitute a voice signal from each natural speech signal present in the selected acoustic units.

Thus through determining and using the acoustic template the process makes it possible to have optimum control over the acoustic parameters of the signal generated with reference to the template.

The process according to the invention will now be described in detail with reference to FIGS. 2 and 3.

Stage 2 of determining acoustic models is conventional. It is carried out on the basis of database 3, which contains a finite number of symbolic units of a phonological nature and the associated voice signals and phonetic transcriptions. This set of symbolic units is subdivided into sets each comprising all the acoustic units corresponding to different productions of the same symbolic unit.

Stage 2 starts with a substage 22 of determining a probabilistic model for each symbolic unit which in the embodiment described is a hidden Markov model with discrete states, currently referred to as HMM (Hidden Markov Model).

These models include three states and are defined by a Gaussian law for each state having a mean p and a covariance Σ which models the distribution of observations and by the probabilities of keeping them as they are and of transition to other states of the model. The parameters constituting an HMM model are therefore the mean and covariance parameters of the Gaussian laws for the different states and the transition matrix containing the different probabilities of transition between the states.

Conventionally these probabilistic models originate from a finite alphabet of models comprising for example 36 different models which describe the probability of the acoustic production of symbolic units of a phonological nature.

In addition to this, the discrete models each include an observable random process corresponding to the acoustic production of symbolic units and a non-observable random process designated Q and have known probabilistic properties known as “Markov properties” according to which implementation of the future state of a random process only depends on the present state of that process.

In the course of substage 22 each natural speech signal included in an acoustic unit is analysed asynchronously with for example a fixed step of five milliseconds and a window of 10 milliseconds. For each window centered on an analysis time t, twelve cepstral coefficients or MFCC coefficients (Mel Frequency Cepstral Coefficient) and the energy are obtained, together with their first and second derivatives.

A spectrum and energy vector comprising the cepstral coefficients and the energy values is referred to as cₜ, and a vector comprising cₜ and its first and second derivatives is referred to as oₜ. Vector oₜ is called the acoustic vector of time t and includes the spectrum and energy information for the natural speech signal analysed.

Through this analysis each symbolic unit or phoneme is associated with an HMM model, known as a left-right three state model, which models the distribution of the observations.

Learning of each of these HMM models is carried out in a conventional way using for example an algorithm known as a Baum-Welch algorithm.

In particular the known mathematical properties of Markov models make it possible to determine the conditional probability of observing the designated acoustic production oₜ, given the state qₜ of the non-observable process Q, referred to as the model probability, denoted Pₘ, and corresponding to:
Pₘ=P(oₜ|qₜ)

Advantageously, stage 2 also comprises a substage 24 of determining probabilistic models adapted to the phonetic context.

More specifically, this substage 24 corresponds to the learning of HMM models of the type known as triphone models.

In fact, in phonology phonemes represent the subdivision of words into their linguistic units.

A phone refers to an acoustic production of a phoneme. Acoustic productions of phonemes differ according to the context in which they are spoken. For example, coarticulation phenomena may occur to a greater or lesser extent depending upon the phonetic context. Likewise there may be differences in acoustic production depending upon the prosodic context.

A conventional method of adaptation to the phonetic context takes into account the left and right hand contexts, and this results in the modelling referred to as triphone. When learning HMM models, for each triphone present in the base the parameters of the Gaussian laws relating to each state are reestimated on the basis of representatives of this triphone.

The probabilities of transition between each state in the models nevertheless remain unchanged.

When there is an insufficient number of representatives of a triphone in the acoustic corpus, the parameters of the model of this triphone risk being poorly estimated. It is however possible to group the phonemes of the left and right hand contexts into classes in order to obtain more generic context-dependent models.

By way of example, different categories of contexts such as plosive, fricative, voiced or unvoiced, are distinguished.

Stage 2 then comprises a substage 26 of classifying the probabilistic models on the basis of their symbolic parameters in order to group them within the same class, the models having acoustic similarities.

Such a classification may for example be obtained through constructing decision trees.

A decision tree is constructed for each state of each HMM model. It is constructed by repeated subdivision of the natural speech segments of the acoustic units of the set in question, these subdivisions being performed on the symbolic parameters.

At each node in the tree a criterion relating to the symbolic parameters is applied in order to separate the different acoustic units corresponding to the acoustic productions of a given phoneme. Subsequently the variation in probability between the parent node and the daughter node is calculated, this calculation being carried out on the basis of the parameters of the previously determined triphone models in order to take the phonetic context into account. The separation criterion which results in the maximum increase in probability is adopted and the separation is effectively accepted if this increase in probability exceeds a fixed threshold and if the number of representatives present at each of the daughter nodes is sufficient.

This operation is repeated on each branch until a stop criterion stops the classification, giving rise to the generation of a leaf of the tree or a class.

Each of the leaves of the tree in a state of the model is associated with a single Gaussian law having a mean μ and covariance Σ, which characterises the representatives of that leaf and which forms the parameters of that state for a contextual acoustic model.

A contextual acoustic model may therefore be defined for each HMM model by the path, of the associated decision tree for each state in the HMM model in order to allocate a class to that state and modify the mean and covariance parameters of its Gaussian law in order to adapt it to the context. The different symbolic units corresponding to different productions of a given phoneme are therefore represented by the same HMM model and by different contextual acoustic models.

Thus for each phoneme characterised by a set of symbolic parameters a contextual acoustic model is defined as being an HMM model whose non-observable process has as its transition matrix that of the model of the phoneme resulting from stage 22 and in which the mean and covariance matrix for the observable process for each state are the mean and the covariance matrix of the class obtained by the path in the decision tree corresponding to the state of that phoneme.

Once the contextual acoustic models have been determined, stage 4 of determining a target sequence of symbolic units is carried out.

This stage 4 first of all comprises a substage 42 of acquiring a symbolic representation of a given text which has to be synthesised, such as a graphemic or spelled presentation.

For example, this graphemic representation is a text drafted using the Latin alphabet referred to by reference TXT in FIG. 3.

The process then comprises a substage 44 of determining a sequence of symbolic units of a phonological nature from the graphemic representation.

This sequence of symbolic units referred to by the reference UP in FIG. 3 comprises for example phonemes extracted from a phonetic alphabet.

This substage 44 is carried out automatically using conventional techniques in the state of the art such as phonetisation or other means.

In particular, this substage 44 uses a system of automatic phonetisation using databases and making it possible to subdivide any text into a finite symbolic alphabet.

Then the process comprises stage 5 of determining a sequence of contextual acoustic models corresponding to the target sequence. This stage first of all comprises a substage 52 of modelling the target sequence by subdividing it on the basis of the probabilistic models and more specifically on the basis of probabilistic hidden Markov models, designated HMM, determined in the course of stage 2.

The sequence of probabilistic models so obtained is referred to as H₁^{M} and comprises models H₁ to H_{M} selected from the 36 models of the finite alphabet, and corresponds to the target sequence UP.

The process then comprises a substage 54 of forming contextual acoustic models by modifying the parameters of the models in the sequence of models H₁^{M} to form a sequence Λ₁^{M} of contextual acoustic models. This is achieved by following the decision trees for each state of each model in the sequence H₁^{M}. Each state of each model is modified and takes the mean and covariance values for the leaf whose symbolic parameters correspond to those of the target.

The sequence Λ₁^{M} of contextual acoustic models is therefore a sequence of hidden Markov models whose mean covariance parameters have been adapted to the phonetic context.

The process then comprises stage 6 of determining an acoustic template. This stage 6 comprises a substage 62 of determining the time duration of each contextual acoustic model by attributing a corresponding number of time units, a substage 64 of determining a time sequence of models and a substage 66 of determining a sequence of corresponding acoustic frames forming the acoustic template, to each contextual acoustic model.

More particularly, substage 62 of determining the time duration of each contextual acoustic model comprises predicting the duration of each state of the contextual acoustic models. This substage 62 receives as an input the sequence of acoustic models Λ₁^{M}, comprising information on the mean, covariance and Gaussian density for each state and the transition matrices, as well as a duration value for each state of the model.

Thus for each contextual acoustic model it is possible to take the mean duration of each of the states of the model.

As a variant, a mean duration is defined for each class and the classification of a state into a class results in the attribution of that mean duration to that state.

Advantageously, a duration prediction model such as exists in the state of the art in particular for attributing a desired value to each phoneme is used to assign a duration to the different states of the sequence Λ₁^{M} of the contextual acoustic models.

It is appropriate to determine the durations of each state of a phoneme on the basis of each reference phonemic duration d. In order to do this it is necessary to calculate the relative duration of each state i for each contextual acoustic model λ, this time being denoted αᵢ^{λ} and is given by the following relationship:

$${α}_{i}^{λ} = \frac{{\overline{d}}_{i}^{λ}}{{\sum }_{i = 1}^{{J}_{i}} {\overline{d}}_{i}^{λ}}$$

$$where$$

$${\overline{d}}_{i}^{λ} = \frac{1}{1 - {a}_{ii}^{λ}} ,$$

where αᵢᵢ^{λ} is the a priori probability of remaining in state i d̅ᵢ^{λ} is the mean duration of state i of model λ, and Jᵢ is the number of states of model λ. The duration of state i of model λ in question is then
d_{hu λ}=αᵢ^{λ}d.

Knowing this value dᵢ^{λ} it is then possible to determine the number of frames of state i for the contextual acoustic model λ in question, which corresponds to its time duration. The total number of frames which have to be synthesised is obtained directly knowing the time duration for each model.

Having determined a sequence of acoustic models and the relative time duration of each model it is possible to generate a time sequence of models in the course of substage 64. Letting N be the total number of frames which have to be synthesised, Λ=[λ₁,λ₂, . . . ,λ_{N}] the sequence of contextual acoustic models, and Q=[q₁,q₂, . . . ,q_{N}] the corresponding sequence of states are determined.

Sequence Λ is a time sequence of models, comprising contextual acoustic models in the sequence Λ₁^{M}, each duplicated several times in relation to its time duration as shown in FIG. 3.

The required template is then determined in the course of substage 66 by determining the sequence of observations O=[o₁^{T}, o₂^{T}, . . . , o_{N}^{T}]^{T} maximising P[O|Q,Λ]. In these equations T corresponds to the transposition operator.

As indicated previously, observation vector oₜ of frame t comprises a static part cₜ=[cₜ(1), cₜ(2), . . . cₜ(P)]^{T}, P being the number of MFCC coefficients, and a dynamic part Δcₜ, Δ²cₜ comprising the first derivative and second derivative of the MFCC coefficients, whence oₜ=[c₁^{T},Δc₁^{T},Δ²cₜ^{T}]^{T} with

$$Δ {c}_{t} = {\sum }_{i = - {L}^{( 1 )}}^{{L}^{( 1 )}} {w}^{( 1 )} ( i ) {c}_{t + i}$$

$$and$$

$${Δ}^{2} {c}_{t} = {\sum }_{i = - {L}^{( 2 )}}^{{L}^{( 2 )}} {w}^{( 2 )} ( i ) {c}_{t + i} .$$

Thus sequence of observations oₜ is fully defined by static part cₜ formed from the spectrum and energy vector, the dynamic part being directly deduced from this.

The observation sequence can also be written in matrix form as follows:
O=W.C,
with C=[c₁,c₂, . . . c_{N}]^{T},
W=[w₁,w₂, . . . , w_{N}]^{T},
wₜ=[wₜ⁽⁰⁾,wₜ⁽¹⁾, wₜ⁽²⁾]
and
wₜ⁽ⁿ⁾[0_{P×P}, . . . , 0_{P×P}, w⁽ⁿ⁾(−L⁽ⁿ⁾)I_{P×P}, . . . , w⁽ⁿ⁾(0)I_{P×P, . . . ,w}⁽ⁿ⁾(L⁽ⁿ⁾)I_{P×P}, 0_{P×P}, . . . , 0_{P×P}]^{T}, n=0,1,2.
Maximising P[O|Q,Λ] in relation to O is the same thing as solving

$$\frac{\partial log P ( O \vert Q , Λ )}{\partial C} = 0 , \\ with$$

$$log P ( O \vert Q , Λ ) = - \frac{1}{2} {O}^{T} {U}^{- 1} O + {O}^{T} {U}^{- 1} M + K , \\ {U}^{- 1} = diag [ {U}_{{q}_{1}}^{- 1} , {U}_{{q}_{2}}^{- 1} , … , {U}_{{q}_{N}}^{- 1} ] , \\ and$$

$$M = {[ {μ}_{{q}_{1}}^{T} , {μ}_{{q}_{2}}^{T} , … , {μ}_{{q}_{N}}^{T} ]}^{T}$$

where β_{q}, is the vector of the means and U_{q}, is the covariance matrix of state qₜ and K is an independent constant of the observation vector O. Equation (11) becomes:
RC=r
with R=W^{T}U⁻¹W
and r=W^{T}U⁻¹M^{T}

As R is a matrix of (NP×NP) elements, the direct solution of equation RC=r requires (N³P³) operations. Alternatively a known iterative smoothing procedure may be used in the course of substage 66 to reduce the complexity of the algorithm.

Solving these equations therefore makes it possible to obtain the acoustic template, denoted C, comprising frames or vectors containing spectrum and energy information.

The acoustic template therefore corresponds to the most likely sequence of spectrum and energy vectors given the sequence of contextual acoustic models.

The process then moves to stage 7 of selecting a sequence of acoustic units.

Stage 7 starts with a substage 72 of determining a reference sequence of symbolic units denoted U. This reference sequence U is formed from the target sequence UP and comprises symbolic units used for synthesis, which may be different from those forming the target sequence UP. For example, the reference sequence U comprises phonemes, diphonemes or others.

In the case where the symbolic units used for synthesis are the same as those used to define the target sequence UP, this sequence is the same as the reference sequence U, so substage 72 is not carried out.

Each symbolic sequence in reference sequence U is associated with a finite set of acoustic units corresponding to different acoustic productions.

Then, in the embodiment described, the process comprises a substage 74 of segmenting the acoustic template on the basis of reference sequence U.

In fact in order to be able to use the acoustic template it is preferable to carry out segmentation of this template on the basis of the type of acoustic units which have to be selected.

It should furthermore be noted that the process according to the invention is applicable to every type of acoustic unit, segmentation substage 74 making it possible to adjust the acoustic template to different types of units.

This segmentation is a breakdown of the acoustic template on the basis of time units corresponding to the types of acoustic units used. Thus this segmentation corresponds to grouping the frames of acoustic template C by segments having a duration close to that of the units in reference sequence U, which correspond to the acoustic units used for synthesis. These segments are denoted sᵢ in FIG. 3.

Advantageously, selection stage 7 comprises a preselection stage 76 which makes it possible to define a subset Eᵢ of possible acoustic units for each symbolic unit Uᵢ in reference sequence U, as shown in FIG. 3.

This preselection is carried out in the conventional way, for example on the basis of the symbolic parameters of the acoustic units.

The process further comprises a substage 78 of aligning the acoustic template with each sequence of possible acoustic units on the basis of the possible units preselected for final selection.

More specifically the parameters of each possible acoustic unit are compared with segments of the corresponding template using an alignment algorithm such as for example an algorithm known as DTW (Dynamic Time Warping).

This DTW algorithm aligns each acoustic unit with the corresponding template segment to calculate an overall distance between them, equal to the sum of the local distances on the alignment path divided by the shortest number of segment frames. The overall distance so defined is used to determine a relative time distance between the signals compared.

In the embodiment described the local distance used is the Euclidian distance between the spectrum and energy vectors comprising the MFCC coefficients and the energy information.

Thus the process according to the invention makes it possible to obtain a sequence of acoustic units selected in an optimum way through use of the acoustic template.

Finally, in the context of a synthesis process, selection stage 7 is followed by a synthesis stage 9 which comprises a substage 92 for the recovery of a natural speech signal in database 8 for each acoustic unit selected, a substage 94 of smoothing the signals and a substage 96 of concatenating different natural speech signals in order to deliver the final synthesised signal.

As a variant, when fundamental frequency prosodic references are provided for duration and energy a prosodic modification algorithm such as for example an algorithm known by the name of TD-PSOLA is used in the synthesis module during a substage of prosodic modification.

Finally, in the example described the hidden Markov models are models whose non-observable processes have discrete values.

However, the process may also be carried out using models in which the non-observable processes have continuous values.

It is also possible to use several sequences of symbolic units for each graphemic representation, the fact of several symbolic sequences being taken into account being known in the state of the art.

In general, this technique is based on the use of language models designed to apply weightings to different hypotheses on the basis of their probability of occurrence in the symbolic universe.

Furthermore, the MFCC spectral parameters used in the example described may be replaced by other types of parameters, such as the parameters known as LSF (Linear Spectral Frequencies), LPC parameters (Linear Prediction Coefficients) or again parameters associated with formants.

The process may also use other characteristic information of voice signals, such as fundamental frequency or voice quality information, particularly in the stages of determining the contextual acoustic models, determining the template and selection.

1-22. (canceled)

23. A process for the selection of acoustic units corresponding to acoustic productions of symbolic units of a phonological nature, the said acoustic units each comprising a natural speech signal and symbolic parameters representing their acoustic characteristics, the said process comprising:
determining at least one target sequence of symbolic units
determining a sequence of contextual acoustic models corresponding to the said target sequence,
determining an acoustic template from the said sequence of contextual acoustic models; and
selecting a sequence of acoustic units on the basis of the said acoustic template applied to the said target sequence of symbolic units.

24. A process according to claim 23, wherein the process comprises, prior to determining at least one target sequence, determining contextual acoustic models carried out on the basis of a given set of acoustic units.

25. A process according to claim 24, wherein contextual acoustic models comprises:
determining a probabilistic model for each acoustic unit obtained from a finite set of models each comprising an observable random process corresponding to the acoustic production of symbolic units and a non-observable random process having known probabilistic properties referred to as “Markov properties”,
classifying the said probabilistic models on the basis of their symbolic parameters,
the observable and non-observable random processes of the models in each class constituting the said contextual acoustic models.

26. A process according to claim 25, wherein determining contextual acoustic models further comprises determining probabilistic models adapted to the phonetic context whose parameters are used in the course of classifying the said probabilistic models.

27. A process according to claim 25, wherein classifying probabilistic models comprises a classification using decision trees, the parameters of the said probabilistic models being modified by the path of the said decision trees to form the said contextual acoustic models.

28. A process according to claim 23, wherein determining at least one target sequence of symbolic units comprises
acquiring a symbolic representation of a text, and
determining at least one sequence of symbolic units from the said symbolic representation.

29. A process according to claim 23, wherein determining a sequence of contextual acoustic models, comprises:
modelling the said target sequence by breaking it down on the basis of probabilistic models in order to provide a sequence of probabilistic models corresponding to the said target sequence; and
forming contextual acoustic models by parameter modification of the said probabilistic models to form the said sequence (Λ₁^{M}) of contextual acoustic models.

30. A process according to claim 23, wherein determining an acoustic template (C) comprises
determining the time period for each contextual acoustic model;
determining a time sequence of models; and
determining a sequence of corresponding acoustic frames forming the said acoustic template.

31. A process according to claim 30, wherein determining the time period of each contextual acoustic model comprises prediction of its duration.

32. A process according to claim 23, wherein the selection of a sequence of acoustic units comprises:
determining a reference sequence of symbolic units from the said target sequence, each symbolic unit in the reference sequence being associated with a set of acoustic units, and
aligning between the acoustic units associated with the said reference sequence and the said acoustic template.

33. A process according to claim 32, selecting a sequence of acoustic units further comprise the segmentation of the said acoustic template on the basis of the said reference sequence.

34. A process according to claim 33, wherein the segmentation comprises a breakdown of the said acoustic template on the basis of time units.

35. A process according to claim 33, wherein when the said template is segmented each segment corresponds to one symbolic unit of the reference sequence and aligning comprises alignment of each segment of the template with each of the acoustic units associated with the corresponding symbolic unit originating from the reference sequence.

36. A process according to claim 32, wherein the alignment comprises the determination of an optimal alignment as determined by an algorithm known as a “DTW” algorithm.

37. A process according to claim 32, wherein the selection further comprises the preselection through which it is possible to determine possible acoustic units for each symbolic unit of the reference sequence, the said alignment substage comprising a substage of final selection between these possible units.

38. A process according to claim 23, wherein the said contextual acoustic models are probabilistic models having observable processes with continuous values and non-observable processes with discrete values forming the states of this process.

39. A process according to claim 23, wherein the said contextual acoustic models are probabilistic models having non-observable processes with continuous values.

40. A process of synthesising a speech signal comprising a selection process according to claim 23, the said target sequence corresponding to a text which has to be synthesised and the process further comprising synthesising a voice sequence from the said sequence of selected acoustic units.

41. A process according to claim 40, wherein synthesis comprises:
recovering a natural speech signal for each acoustic unit selected,
smoothing the speech signals, and
concatenation of the different natural speech signals.

42. A device for selecting acoustic units corresponding to acoustic productions of symbolic units of a phonological nature, comprising suitable means for carrying out a selection process according to claim 23.

43. A device for the synthesis of a speech signal, including means suitable for carrying out a selection process according to claim 23.

44. A computer program on a data carrier, comprising suitable instructions for carrying out a selection process according to claim 23 when the program is loaded into and run on a data processing system.
